(19) United States
(12) Patent Application Publication
(10) Pub. No.: US 2025/0262637 A1
(43) Pub. Date: Aug. 21, 2025

(54) PORTABLE SURFACE PREPARATION AND COATING PRODUCTION APPARATUS AND METHOD THEREOF

(71) Applicant: Blastmaster Holdings USA, LLC, Columbus, OH (US)

(72) Inventor: Trevor GOODEN, Blacklick, OH (US)

(21) Appl. No.: 19/055,030

(22) Filed: Feb. 17, 2025

Related U.S. Application Data
(60) Provisional application No. 63/553,945, filed on Feb. 15, 2024.

(51) Int. Cl. B05B 16/80; B05B 16/40; B05B 16/60

(52) U.S. Cl. CPC B05B 16/80; B05B 16/40; B05B 16/60

(57) ABSTRACT

Provided in this disclosure is a portable facility for surface coating and surface preparation. The portable facility assists with surface preparation and coating production in shipyards and other environments such as rural areas or other remote locations that otherwise do not have traditional industrial support. Operative connectivity to a blast pot control via smart devices creates faster production cycles and reduced operational costs. The portable facility and air plenums also enhance environmental sustainability and improve worker safety through various means of ventilation and reducing energy consumption. Nozzles reduce blasting time, lower process noise, and reduce user fatigue.

### CROSS-REFERENCE TO RELATED APPLICATIONS

This non-provisional application claims priority to U.S. Provisional Patent Application Ser. No. 63/553,945, filed on Feb. 15, 2024, which is incorporated herein by reference.

### I. BACKGROUND

### A. Technical Field

This invention pertains generally to the field of surface coating and surface preparation, particularly portable facilities for surface coating and surface preparation.

The present disclosure relates to a portable facility for surface preparation and coating surface preparation and coating production and more particularly to a portable facility for surface preparation and coating surface preparation and coating production in shipyards and supplier production environments. Any references to methods, apparatuses, or documents of the prior art are not to be taken as constituting any evidence or admission that they formed, or form, part of the common general knowledge.

### B. Description of Related Art

In surface preparation and coating production, individual components are arranged in combinations. One such arrangement, as used in surface preparation and coating production, includes a dead man control, manually operable control, a handle, and a nozzle. Such “A Dead Man Control Arrangement,” is disclosed in U.S. patent application Ser. No. 17/626,597, filed Jan. 12, 2022 claiming priority to PCT/AU2020/050720 filed Jul. 12, 2019, which is incorporated herein by reference. Importantly, this disclosure teaches a “nozzle arrangement for use in expelling pressurized fluid includes a dead man control. The dead man control has a manually operable control part movable between a non-operating position, which prevents operation of the nozzle arrangement, and an operating position, and biased towards the non-operating position. The manually operable control part is pivotably coupled relative to a nozzle holder of the nozzle arrangement, which extends away from the pivotal coupling substantially towards a distal end of a nozzle part of the nozzle arrangement. The manually operable control part includes a handle part which in the operating position is substantially against and aligned with the nozzle part.”

Another component, as used in surface preparation and coating production, is a blast nozzle. One such disclosure capturing the essence of this component is “An Improved Blast Nozzle,” disclosed in U.S. patent application Ser. No. 18/018,557, filed Jan. 28, 2023 claiming priority to PCT/AU2021/050827 filed Jul. 29, 2021 which is incorporated herein by reference. This disclosure teaches a blast nozzle with a “conduit through it for accelerating air applied to the blast nozzle at pressure greater than ambient pressure. The air contains abrasive particles for abrading or ‘blasting’ a workpiece. The conduit includes an inlet portion that converges from an inlet opening for receiving the air, to a throat for accelerating the air to a sonic speed. The conduit also includes an outlet portion that extends from the throat to a nozzle outlet for accelerating the air from the throat to a super-sonic speed at the nozzle outlet. A ratio of area of the nozzle outlet to area of the throat is selected for expansion of the air through the conduit so that air is emitted from the nozzle outlet in a jet at an ambient pressure. The jet imparts drag on the abrasive particles between the nozzle outlet and the workpiece which has been found to improve abrading of the workpiece by the abrasive particles.”

Yet another component used in the surface preparation and coating production process is a silencer for a blast nozzle. A disclosure teaching this component is a “Silencer For A Blast Nozzle,” disclosed in U.S. patent application Ser. No. 18/039,598, filed May 31, 2023 claiming priority to PCT/AU2021/051437 filed Dec. 2, 2021 which is incorporated herein by reference. This disclosure teaches a “noise suppressed blasting system comprising: a source of blasting gas in a predetermined pressure range with abrasive particles entrained therein; a nozzle including a nozzle inlet for connection to the source of blasting gas, a nozzle outlet for emission of the blasting gas, a nozzle conduit from the nozzle inlet to the nozzle outlet including a throat therebetween with a ratio of area of the nozzle outlet to area of the throat selected to emit the blasting gas from the nozzle outlet to produce a supersonic jet; a silencer connectable to the nozzle, to receive the supersonic jet exiting the nozzle, the silencer comprising a body with a silencer conduit therethrough, the body being of sufficient length and diameter to cause a flow condition of the jet received from the nozzle outlet to be modified such that 1 ½ shock cells are created in a jet inside the silencer, no shock cells are created in the jet outside the silencer and a jet exits the silencer in the form of a core jet with an established turbulent shear layer thereabout and entraining an annular jet located around the core jet.”

An additional component used in the surface preparation and coating production process is a thrust reduction system. One disclosure teaching this component is a “Thrust Reduction System For A Blast Nozzle,” disclosed in U.S. patent application Ser. No. 18/039,702, filed May 31, 2023 claiming priority to PCT/AU2021/051438 filed Dec. 2, 2021 which is incorporated herein by reference. This disclosure teaches a “blast nozzle thrust reduction blasting system comprising: a source of blasting gas in a predetermined pressure range with abrasive particles entrained therein; a nozzle including a nozzle inlet for connection to the source of blasting gas, a nozzle outlet for emission of the blasting gas, a nozzle conduit from the nozzle inlet to the nozzle outlet including a throat therebetween with a ratio of area of the nozzle outlet to area of the throat selected to emit the blasting gas from the nozzle outlet to produce a supersonic jet; a thrust reducer connectable to the nozzle, to receive the supersonic jet exiting the nozzle, the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.”

An additional feature in the system for surface preparation and coating production is operative connectivity via a smart device. One such disclosure is a “Distributed Smart Thermostat,” disclosed in U.S. patent application Ser. No. 18/350,270, filed Jul. 11, 2023 which is incorporated herein by reference. This disclosure teaches a distributed thermostat including “a controller unit that houses a controller operable to control operation of a heating, ventilation, and air conditioning (HVAC) system. The controller is further operable to receive environmental information from a sensor network that is distributed from the controller unit; receive user inputs from a user interface application that is distributed from the controller unit; and control the operation of the HVAC system based at least in part on the environmental information and the user inputs.”

Another feature in the system for surface preparation and coating production includes a containment system that is mobile. One such disclosure is a “Decontainment And Containment Trailer And Roll-off System,” disclosed in U.S. patent application Ser. No. 14/533,621, filed Nov. 5, 2014 and issued May 24, 2017 which is incorporated herein by reference. This disclosure teaches a “a new and improved mobile washing and decontamination apparatus, system and method of using the same to provide an easily moveable, quick deploying mobile containment system that allows total containment for toxic and nontoxic materials that occur during wash and service of heavy equipment, vehicles, and or parts as well as provide a temporary containment or secondary containment to prevent fluid and debris runoff during storage, wash, service, assembly and disassembly of potential contaminated equipment.”

In the subsequent patent disclosure, the portability of facilities for surface coating and surface preparation will be discussed in detail. Many variations are possible and are only limited to the imagination of the engineer.

### II. Summary

Despite these advances in the surface preparation and coating production industry, there is a need for a portable facility incorporating these components, in addition to others, together in one system to synergistically increase production, especially in shipyards and supplier production environments. A person having ordinary skill in the art would understand that the conventional methods for the surface preparation and coating production systems disclosed above require a fixed location and do not account for the convenience and efficiency of portability. Accordingly, the present disclosure involves multiple components, which provides faster production cycles, reduced operational costs, enhanced environmental sustainability, and improved worker safety. These individual components are discussed in turn. Additionally, ventilation in the portable facility could be downdraft, semi-downdraft, side-downdraft, crossflow, or any combination thereof.

According to one aspect of the present disclosure, a blast pot control, providing control for optimization of blasting parameters for efficient and effective surface preparation and coating production. One skilled in the art would appreciate that this control could be a smart control operated with smart devices, such as smartphones. Smart controls are Wi-Fi controls that can be used with automation and are responsible for controlling a blast pot. Smart controls allow users to control the blast pot throughout the disclosed portable facility for surface preparation and coating production via sensors and Wi-Fi connectivity, enabling the blast pot control to connect to the Internet. One skilled in the art would recognize that users can remotely adjust or control a blast pot from other Internet-connected devices, such as a laptop, smartphone, or tablet.

The blast pot control could be electric, mechanical, or any other means used by the skilled artisan. In terms of components, the blast pot control would comprise a piston, a spring, and an O-ring. The blast pot control would not require a maximum fill for operation and could function with electric blast pots, pneumatic blast pots, contractor blast pots, wet abrasive blasters, robotic blast machines, blast and vacuum blasters, track blasters, or any other type of blaster or blast pot used by the skilled artisan.

According to another aspect of the present disclosure, nozzles engineered for precise and effective material removal could be included in the portable facility. In addition, these nozzles reduce blasting time and lower process noise. For example, in one embodiment, the SNAKEBITE XQ™ blast nozzle, provides up to 16 decibel (dBA) noise reduction and less fatigue compared to standard blast nozzles. Furthermore, this exemplary embodiment offers improved nozzle geometry, a quick-connect nozzle silencer, a durable and lightweight silicon nitride nozzle, and silencer liner.

Additionally, this exemplary embodiment showcases a slimline ergonomic nozzle jacket, a standard contractor nozzle inlet thread, and multiple pressure-ranged options including (1) a standard pressure nozzle, effective for 90 pound per square inch (psi) to 110 psi, and (2) a low-pressure nozzle, effective for 70 psi to 90 psi. Other benefits include improved nozzle liner wear characteristics and service life, an increased ability to meet employee noise exposure regulations, lower risk of operator and bystander hearing-related injuries, reduced noise impact on noise sensitive areas, reduced operator fatigue (both over a work period and on an ongoing basis, enabling high cleaning rates), and reduced risk of worker manual handling related injury and injury caused by loss of operator nozzle control.

The nozzle comprises a body of hardwearing material through which a conduit for the stream of pressurized gas is formed. In some instances, the conduit is shaped such that the nozzles comprise a converging inlet portion, which includes an inlet opening for coupling to a source of the pressurized gas, such as a blast pot. In addition, the inlet portion converges to an aperture from which an outlet portion of the conduit extends to a nozzle outlet. This convergence of the inlet portion to the aperture increases the velocity of the pressurized gas to sonic speeds. Furthermore, the outlet portion may be formed to diverge from the aperture to the nozzle outlet to increase the velocity of the air such that the jet that is emitted from the nozzle outlet is at a high velocity.

One embodiment of the nozzle would have refined internal geometry with a non-silencing bump cap producing a usable cleaning speed. In addition, this embodiment of the nozzle would also include a silicone nitride composition to extend usable life. In another embodiment, the nozzle would comprise a jacket fabricated from anodized aluminum with an ergonomic shape. In another embodiment, the nozzle would have an aperture ranging in size and overall length ranging from 7 inches to 15 inches, depending on aperture size. In terms of abrasives for blasting, one skilled in the art would understand that the nozzle can utilize GMA garnet, aluminum oxide, soda, coal slag, copper slag, corn cob, glass bead, crushed glass, staurolite, steel grit, steel shot, walnut shell, or any other abrasive used by the skilled artisan in blasting.

According to an additional aspect of the present disclosure, a containment system (e.g., booth), could be deployable in a wide variety of settings. In addition, such a containment system ensures a controlled environment while simultaneously minimizing the spread of contaminants. The containment system comprises at least one opening to receive material, equipment, and other implements susceptible to blasting and coat production. The opening can further accept a barrier to create a more controlled environment. The containment system may further comprise a swivel or caster, allowing for freedom of movement for the containment system on a surface or platform. And the containment system may employ permanent or temporary mounts and, in addition, provide a water-resistant or waterproof design. Furthermore, one skilled in the art would understand the containment system would be modifiable to possess a wind rating commensurate with location needs.

The containment system may or may not require a concrete foundation, allowing for faster setup, and would be compatible with other equipment used in the surface preparation and coating production process, including abrasive recovery and dust collection equipment. The containment system could be made of metal, a polymeric material, a combination thereof, or any other material used by the skilled artisan for containment of material generated during surface preparation and coating production. The containment system could be fabricated as a new construction or retrofitted to existing structures. The skilled artisan would understand that the containment system could also comprise a bench booth, an economy spray booth, a heated spray booth, an open face booth, an enclosed spray booth, a filter wall system, a retractable spray booth, an industrial spray booth, a ship module spray booth, a curing oven, a container spray booth, or provide paint storage and mix rooms.

In terms of curing, the containment system could further comprise a heat-mediated cure, an aquatic-mediated cure, a radiator-mediated cure, or any other curing means used by the skilled artisan. Also, in one exemplary embodiment of the containment system, a port facilitating an at least one operative connection for an air compressor, an air plenum, blasting equipment, a blaster pot control, coat production equipment, dehumidification equipment, a dust collector, a vacuum, or any other equipment used by the skilled artisan in blasting and coat production.

According to yet another aspect of the present disclosure, an airflow modulator is part of a containment system and is designed to lower energy consumption, enhance ventilation, and ensure the efficient removal of particles from surface preparation and coating areas. The airflow modulator is designed with current capacity capable of interacting with high efficiency motors. The skilled artisan would appreciate that the air modulator could comprise a fan, a valve, a sensor, a combination thereof, or other flow regulation devices used by the skilled artisan to supply low pressure or high pressure in the portable facility for surface preparation and coating production. The airflow modulator could be fabricated via metal, or any other material used by the skilled artisan for modulating airflow.

According to a further aspect of the present disclosure the portable facility has combination dual air plenums. These plenums provide uniform and controlled airflow, helping optimize surface preparation and coating processes. In addition, these plenums intake, distribute, and remove air and particles attendant in surface production and coating preparation. The combination dual air plenums have two units: the air supply plenum and the air return plenum. The air supply plenum allows for intake of air and distribution of the air. Alternatively, the air return plenum empowers the portable facility to receive used air, such as that having particulate matter used or created in surface preparation and coating production. The combination dual air plenums could be constructed of metal, or any other material used by the skilled artisan for constructing air plenums.

According to yet another aspect of the present disclosure, the portable facility has a single air plenum. This allows natural air to enter the portable facility on one side, distribute throughout the facility to cool and ventilate the portable facility, removing particles attendant in surface preparation and coating production. The air could then exit out of the single plenum allowing for a constant flow of fresh air. This single plenum cross-flow ventilation system could be used in areas with natural breezes, such as near the waterfront. The air plenum could be constructed of metal, or any other material used by the skilled artisan for constructing an air plenum.

According to another aspect of the present disclosure, an energy recovery system (“ERS”) captures and recycles heat energy, helping reduce the overall energy consumption and operational costs. The ERS may comprise a static-plate core, rotating wheel, or any other implement used by the skilled artisan to attain any amount of energy recovery.

According to one more aspect of the present disclosure, a robot ready design allows for surface preparation and coating production capable of supporting automated process equipment. In one embodiment of the portable facility for surface preparation and coating production, a power supply sufficient to support automated process equipment would be housed inside or adjacent to the containment system. The robot ready design would allow the portable facility to operationally house robotic painting equipment, personnel lifts, overhead conveyors, or any other implement used by the skilled artisan to support the automated process.

Accordingly, the present disclosure provides an operative connection among these several different disclosed components. This operative connectivity creates faster production cycles, reduced operational costs, enhanced environmental sustainability, and improved worker safety. For example, such a portable facility for surface preparation and coating production could be used on remote locations, including in rural settings far removed from traditional industrial support. The remote locations could be non-stationary, such as on a barge, an aircraft carrier, or any other moving base used by the skilled artisan.

Also, the portable facility for surface preparation and coating production could be near coasts, which would enable the portable facility to offer surface preparation operations and coating (e.g., painting) for fabricated components, vehicles, boats, vessels, or aircraft. Providing this enablement creates decreased turnaround time for fabricated components, vehicles, boats, vessels, or aircraft, expediting return to service. This enablement would mitigate shortages attendant in warfare, natural disasters, emergency situations, or other circumstances where time is of the essence.

The skilled artisan would understand that there are many methods of conducting surface preparation and coating production in a portable facility. In one example of the method, a section of a containment system is operatively urged with another section of a containment system to facilitate a controlled environment. Both sections of the containment system have interior and exterior surfaces. In another example of the method, a user can operatively connect to a blast pot control, air plenums, and an energy recovery system of the containment system. This operative connectivity creates faster production cycles, reduced operational costs, enhanced environmental sustainability, and improved worker safety.

Other benefits and advantages of this invention will become apparent to those skilled in the art to which it pertains upon reading and understanding of the following detailed specification.

### III BRIEF DESCRIPTION OF THE DRAWINGS

For a fuller understanding of the nature and advantages of the present method and process, reference should be had to the following detailed description taken in connection with the accompanying drawings, in which:

FIG. 1 is an isometric view of a section of a representative containment system.

FIG. 2 is another isometric view of two sections of the representative containment system.

FIG. 3 is another isometric view of multiple combined sections of the representative containment system.

FIG. 4 is an isometric view of a facility, showcasing the robot ready with an airflow design with dual air plenums and an energy recovery system.

FIG. 5 shows four styles of ventilation used in the portable facility.

FIG. 6 shows a side view of a nozzle used in abrasive blasting.

FIG. 7 shows a front view of a blast pot control service kit.

The drawings will be described in greater detail below.

### IV. DETAILED DESCRIPTION

Referring now to the drawings wherein the showings are for purposes of illustrating embodiments of the article only and not for purposes of limiting the same, and wherein like reference numerals are understood to refer to like components:

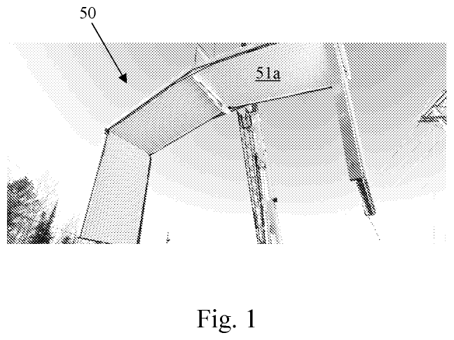

FIG. 1 discloses an isometric view of one section 51a of one exemplary embodiment of a containment system 50. The skilled artisan would understand that section 51a of the containment system 50 is movable, such that it can be placed in remote locations and would not require a concrete foundation.

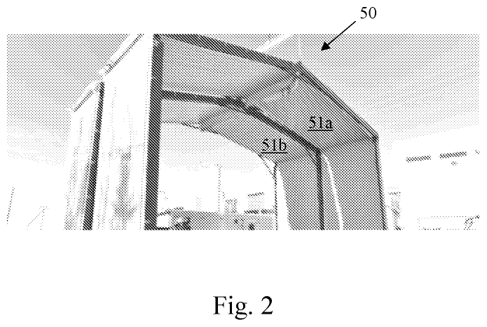

FIG. 2 discloses an isometric view of two sections 51a and 51b of an exemplary embodiment of the containment system 50. The two sections 51a and 51b of the containment system 50 can be urged towards each other in a mirror-like fashion to create a tunnel-like structure, thereby creating a more controlled environment for surface preparation and coating production.

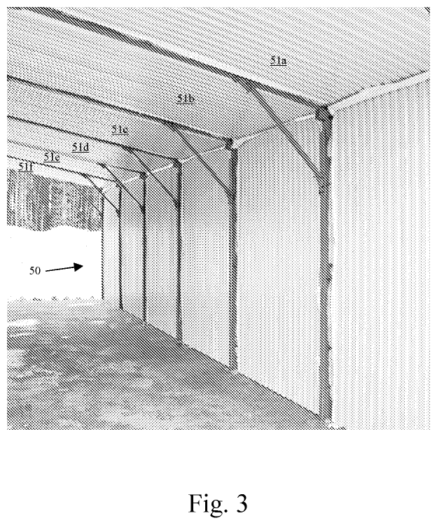

FIG. 3 is another isometric view of multiple combined sections 51a, 51b, 51c, 51d, 51e, and 51f of the containment system 50. The combined sections 51a, 51b, 51c, 51d, 51e, and 51f can be sequentially urged together in a mirror-like fashion to create an even more controlled environment than disclosed in FIG. 2. Furthermore, the skilled artisan would understand that any of the combined sections 51a, 51b, 51c, 51d, 51e, and 51f could be modified, such as creating an aperture on the exterior surface or interior surface of combined sections 51a, 51b, 51c, 51d, 51e, and 51f, to receive or operatively connect to equipment used in surface preparation and coating production. The skilled artisan would also understand that section 51a and 51f could accept a barrier (e.g., a door, a cloth barrier, etc.) over the opening outside of the containment system 50, thereby allowing for a controlled environment to minimize the spread of contaminants intrinsic in the blasting. The connective nature of combined sections 51a, 51b, 51c, 51d, 51e, and 51f allows for rapid deployment, especially in remote settings.

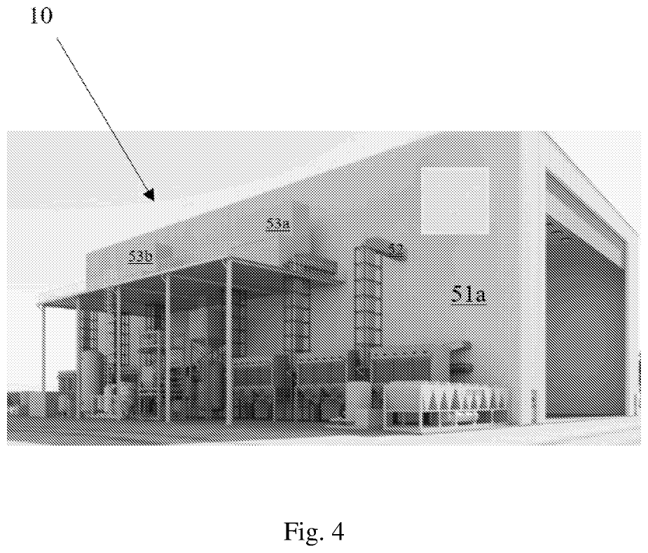

FIG. 4 discloses an isometric view of an exemplary portable facility 10, showcasing the robot ready design with an energy recovery system 52 and airflow via the dual air plenums 53a and 53b. The skilled artisan would understand that although not shown in FIG. 4, other components, such as a blast pot control, could be operatively connected to portable facility 10, thereby facilitating surface preparation and coating production. In addition, portable facility 10 comprises at least one section 51a of the containment system 50.

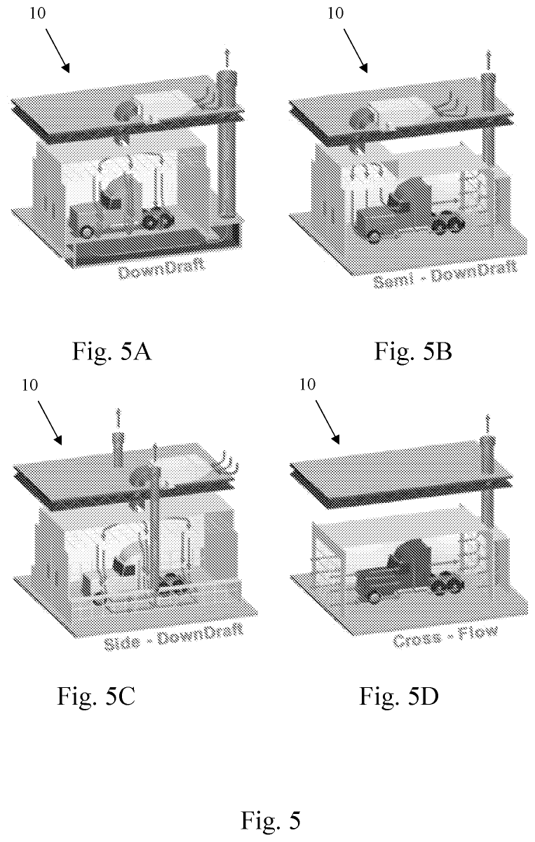

FIG. 5 discloses an isometric view of an exemplary portable facility 10 with four illustrative styles of ventilation used in surface preparation and coating production. FIG. 5A shows downdraft ventilation. FIG. 5B shows semi-downdraft ventilation occurring in portable facility 10. FIG. 5C shows side-downdraft ventilation in portable facility 10. Finally, FIG. 5D shows crossflow ventilation. Each of these four illustrative ventilation styles could be employed in the portable facility 10 to create foster faster turnaround times in surface preparation and coating.

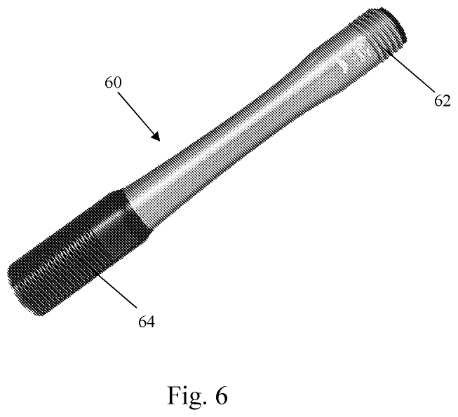

FIG. 6 discloses a side view of a nozzle 60 used in blasting. The nozzle 60 has a thread 62 on one end, allowing for compatibility and operative connectivity with other equipment used in blasting and coating production. In addition, on the other end of the nozzle 60 is a durable and lightweight silicon nitride nozzle silencer 64. The durable and lightweight silicon nitride nozzle silencer 64 would help reduce process noise while simultaneously providing the precision needed to reduce blasting time.

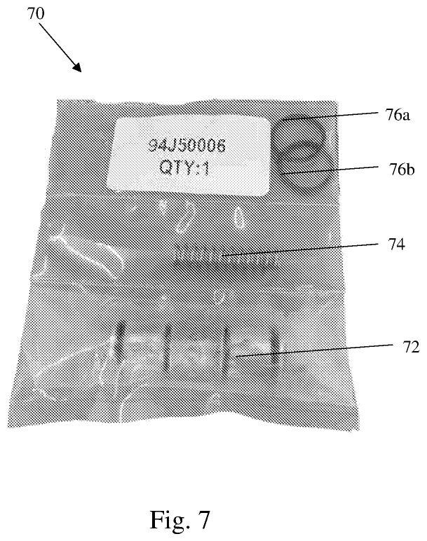

FIG. 7 discloses a front view of blast pot control 70 service kit. The blast pot control 70 service kit comprises a piston 72, a spring 74, and two O-rings 76a and 76b. The skilled artisan would understand that these components (i.e., a piston 72, a spring 74, and two O-rings 76a and 76b) are not an exhaustive list of components able to form a blast pot control 70 service kit.

While the apparatus, system, and method have been described with reference to various embodiments, those skilled in the art will understand that various changes may be made, and equivalents may be substituted for elements thereof, without departing from the scope and essence of the disclosure. In addition, many modifications may be made to adapt a particular situation or material in accordance with the teachings of the disclosure without departing from the essential scope thereof.

Therefore, it is intended that the disclosure is not limited to the embodiments disclosed, but that the disclosure will include all embodiments falling within the scope of the appended claims. In this application all units are in the metric system and all amounts and percentages are by weight, unless otherwise expressly indicated. Also, all citations referred to herein are expressly incorporated herein by reference.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A portable facility, having a robot ready design, used in surface preparation and coating production, the portable facility comprising:
a containment system comprising:
at least one section, having an interior surface and an exterior surface, wherein the containment system facilitates a controlled environment in surface preparation and coating production; and
an airflow design facilitating removal of particles attendant in surface preparation and coating production;
at least one air plenum; and
an energy recovery system.

2. The containment system of claim 1, wherein the containment system can operatively connect to at least one air plenum.

3. The containment system of claim 1, wherein the containment system can operatively connect to the energy recovery system.

4. The portable facility of claim 1, further comprising a nozzle.

5. The nozzle of claim 4, wherein the nozzle further comprises a jacket.

6. The nozzle of claim 4, wherein the nozzle is fabricated from anodized aluminum jacket.

7. The nozzle of claim 4, wherein the nozzle further comprises an anodized aluminum jacket and a silicon nitride composition liner.

8. A method of conducting surface preparation and coating production in a portable facility, having a robot ready design, used in surface preparation and coating production, wherein a user:
urges one section of a containment system, the section having an interior surface and an exterior surface, towards at least one additional section of a containment system, having an interior surface and an exterior surface, wherein the urged sections of the containment system facilitate a controlled environment for surface preparation and coating production; and
operatively connects to the containment system:
at least two air plenums, and
an energy recovery system.

9. The method of claim 8, wherein the portable facility further comprises a nozzle.

10. The method of claim 9, wherein the nozzle further comprises a jacket.

11. The method of claim 9, wherein the nozzle further comprises an anodized aluminum jacket.

12. The method of claim 9, wherein the nozzle further comprises an anodized aluminum jacket and a silicon nitride composition liner.

13. A portable facility, having a robot ready design, used in surface preparation and coating production, the portable containment system comprising:
a blast pot control capable of modifying blasting parameters, wherein the blast pot control can be controlled via a smart device,
a blasting nozzle capable of providing up to 16 dBA noise reduction, comprising:
a jacket, wherein the jacket
is comprised of anodized aluminum, and
ranges in size from 7 inches to 15 inches,
a liner, wherein the liner is comprised of a silicon nitride composition;
a containment system comprising:
at least one metal section, having an interior surface and an exterior surface, and capable of operatively connecting at least one other metal section via urging in a mirror-like fashion, wherein the containment system facilitates a controlled environment in surface preparation and coating production,
at least one opening for receiving at least a portion of a ship or similar components, wherein the at least one opening can accept a barrier to create a more controlled environment, and
an airflow design, wherein the airflow design facilitates removal of particles attendant in surface preparation and coating production,
provides ventilation, and
lowers energy consumption;
at least two air plenums, wherein
at least one air plenum is an air supply plenum, and
at least one air plenum is an air return plenum; and
an energy recovery system, wherein the energy recovery system is capable of capturing and recycling heat energy,
reducing energy consumption, and
operational costs.
